(19) United States
(12) Patent Application Publication
(10) Pub. No.: US 2011/0208372 A1
(43) Pub. Date: Aug. 25, 2011

(54) POWER GENERATION SYSTEM AND METHOD OF OPERATING A POWER GENERATION SYSTEM

(75) Inventors: Erik Hansen, Toftlund (DK); Dennis Roy Andersen, Herlev (DK); Anders Hyldgard, Brondby (DK); Anders Michael Jorgensen, Hillerod (DK)

(73) Assignee: SUNSIL A/S, Toftlund (DK)

(21) Appl. No.: 13/121,968

(22) PCT Filed: Sep. 30, 2009
(86) PCT No.: PCT/DK2009/050253

§ 371 Date: Mar. 31, 2011

Related U.S. Application Data
(60) Provisional application No. 61/101,793, filed on Oct. 1, 2008.

(51) Int. Cl. G06F 1/28

(52) U.S. Cl. 700/297

(57) ABSTRACT

The present invention relates to a power generation system PGS comprising—a system intermediate output SIO, —a central controller CC, and—at least two DC/DC converters DD1, DD2, DDn each comprising—a power input PI1, PI2, PIn for connecting to an output of one or more solar cells SC1, SC2, SCn, —a control input CI1, CI2, CIn, and—a power output PO1, PO2, POn, wherein said power outputs PO1, PO2, POn of said at least two DC/DC converters DD1, DD2, DDn are coupled in series to establish an accumulated system output voltage or in parallel to establish an accumulated system output current, or a combination thereof, at said system intermediate output ISO, and wherein said central controller CC is arranged to be able to selectively set, via said control inputs CI1, CI2, CIn, an output state of each of at least two of said DC/DC converters DD1, DD2, DDn. The present invention further relates to a method of operating a power generation system PGS comprising a plurality of DC/DC converters DD1, DD2, DDn each connected to at least one solar cell SC1, SC2, SCn and having their power outputs PO1, PO2, POn coupled in series or in parallel to provide an accumulated system output voltage or an accumulated system output current, respectively, at a system intermediate output SIO, characterised in that a central controller CC selectively sets an output state of each of at least two of said DC/DC converters DD1, DD2, DDn.

### FIELD OF THE INVENTION

The present invention relates to solar cell technology, in particular how to operate a PV module most efficiently.

### BACKGROUND OF THE INVENTION

Solar cells, also referred to as photovoltaic cells, are widely used for producing electric power from light. The voltage established by a single solar cell without load depends mostly on the type of cell, e.g. approx. 0.5 V for silicon cells and approx. 2 V for multi junction cells. The current depends on the area and the efficiency of the cell, and in turn e.g. the purity of the material and the electrical connections. The voltage of a single cell is therefore typically too low for direct use, which is why several solar cells, e.g. 36 or 72, are typically connected in series to produce e.g. 18-36 V DC. Several such PV modules may be connected in parallel to multiply the current, e.g. for charging 12 or 24 V batteries in an island system, or several PV modules may be connected in series to multiply the voltage to e.g. 300-600 V DC and use it as input to a DC/AC converter for establishing e.g. 110, 230 or 400 V AC suitable for common grid connection or for driving devices normally powered by the mains.

When several PV modules each comprising several series connected solar cells are connected in either series or parallel, the modules with the lowest current or voltage, respectively, will drag all modules down to that level, as a series connection forces equal current, and a parallel connection forces equal voltage. This problem has been solved by providing each module with a maximum power point tracking mechanism, e.g. effectuated by a controllable DC/DC-converter for each module which converts the actual module output to a predetermined current or voltage, respectively. The same problem arises even with single PV modules when the load forces a certain voltage or current, e.g. for charging a battery. This has also been solved by implementing a maximum power point tracking mechanism between the PV module and the load. The use of maximum power point tracking per PV module significantly improves the efficiency of a solar power system, in particular at times when some modules receive less sun light, e.g. because of shadows, than the other.

However, even in the individual PV modules comprising e.g. 72 solar cells coupled in series, the same problem applies: the least efficient solar cell drags the current of all solar cells down to the least common current. This problem has been solved by providing each individual solar cell with a maximum power point tracking mechanism, e.g. as disclosed in WO 2006/005125 A1 Central Queensland University, hereby incorporated by reference. This enables the individual solar cells to each work at their maximum power point, possibly at different voltages and currents, and still be coupled together in series at a common current value to establish the desired module output voltage. WO 2006/005125 A1 further discloses substituting the current filtering inductors from each DC/DC converter, e.g. 72 inductors, with a single, common current filtering inductor at the module output terminal. Finally, WO 2006/005125 A1 also discloses how to reduce the switch noise and transients of the e.g. 72 DC/DC converters by clever control of the switch times, i.e. having all DC/DC converters switching at the same frequency but with their phases relative to each other.

Even though the several DC/DC converters suggested in WO 2006/005125 A1 have reduced spatial requirements due to the substitution of individual filtering inductors for a single, common inductor, their large number still multiplies the requirements for microelectronic circuits as each DC/DC converter features an entirely self-contained maximum power point tracking controller. Furthermore, the distribution of the maximum power point tracking mechanism, which is good because it avoids having badly performing single solar cells influencing the other solar cells, however, also disables an overall control and monitoring mechanism.

Some objects of the present invention are therefore to reduce the requirements to the individual DC/DC converters in a distributed DC/DC converter PV module, and to facilitate central control of the individual DC/DC converters.

### SUMMARY OF THE INVENTION

The present invention relates to a power generation system PGS comprising
a system intermediate output SIO,
a central controller CC, and
at least two DC/DC converters DD1, DD2, DDn each comprising
   a power input PI1, PI2, PIn for connecting to an output of one or more solar cells SC1, SC2, SCn,
   a control input CI1, CI2, CIn, and
   a power output PO1, PO2, POn,
      wherein said power outputs PO1, PO2, POn of said at least two DC/DC converters DD1, DD2, DDn are coupled in series to establish an accumulated system output voltage or in parallel to establish an accumulated system output current, or a combination thereof, at said system intermediate output ISO, and

wherein said central controller CC is arranged to be able to selectively set, via said control inputs CI1, CI2, CIn, an output state of each of at least two of said DC/DC converters DD1, DD2, DDn.

By the present invention an advantageous system which combines individual power point tracking of the solar cells with central control is provided. Thereby the requirements to the individual DC/DC converters are reduced while the possible information and control at a central level is significantly improved. In other words, or comparing with other known systems, central control and information gathering allow for control of the system-level maximum power point while accurate and efficient power point tracking and conversion is distributed to the individual solar cells.

Some of the advantages of the present invention comprise:
All solar cells in a PV module produce the highest possible power in an autonomous way, i.e. without being limited by the capabilities of other solar cells. Apart from the clear advantage of more power, this also facilitates cheaper and easier manufacture of PV modules. This is due to the common need to match solar cells to be placed in the same module and the manufacture of high-efficient and low-efficient modules due to the purity of the solar cells is now eliminated with the present invention.
All DC/DC converters operate independently with respect to each other, but are controlled by a central controller. Thereby, optimum power efficiency and possibly reduced requirements to the individual DC/DC converter implementations is achieved, while at the same time facilitating improved central control and information exchange. Systems with either distributed DC/DC converters or a single central DC/DC converter are controlled from only one perspective: either a detailed low-level perspective causing high efficiency but no overall fine tuning, or a high-level perspective causing fine overall output control but low efficiency. The present invention facilitates both: i.e. low-level control causing high efficiency and high-level control causing fine and multi-facetted overall output control according to external requirements.
The maximum power point tracking is carried out locally in each DC/DC converter, but the DC/DC converters are also controlled by a central controller which is able to set the common current, or voltage, respectively, that all DC/DC converters have to adapt to. So, even though the individual DC/DC converters do no consider each other or other system conditions when carrying out their individual power point tracking, they are in fact indirectly adapting to overall, higher level decisions made by the central controller on the basis of input from the DC/DC converters, system current and voltage measurements, etc. This way an overall control mechanism for fine tuning and/or enforcing system decisions is provided quite elegantly causing neither bureaucracy nor anarchy. In a preferred embodiment of the present invention there is one DC/DC converter for each solar cell, and one central controller for each module of solar cells and DC/DC converters, and optionally also one inverter for each PV module. In a preferred embodiment, the solar cell may be divided into sub-cells coupled in series in order to provide a higher initial voltage. Other variants, e.g. comprising a few solar cells for each DC/DC converter, or comprising e.g. two central controllers for one module, e.g. one for each half-module, or comprising a central controller handling even more than one PV module, is within the scope of the present invention. Also, the coupling of several modules before or after converting the direct current to alternating current is within the scope of the present invention.

According to the present invention, output state refers to characteristics or operational parameters related to or influencing the power output of the DC/DC converter. Examples are given below.

When said output state is selected from a list of at least
a state of contributing power and
a state of not contributing power,
   an advantageous embodiment of the present invention is obtained.

According to the present invention, an advantageous control possibility for the central controller CC striving to achieve optimal system efficiency lies in turning specific DC/DC converters off when it can be determined that they actually drag the system down rather than contribute.

When said output state is selected from a list of at least one or more of
a state of seeking a predetermined output power,
a state of seeking a predetermined output current,
a state of seeking a predetermined output voltage, and
a state of seeking a predetermined output voltage and a predetermined output current,
   an advantageous embodiment of the present invention is obtained.

According to the present invention, the central controller preferably has other control possibilities also, as mentioned above. The different settings may be used by the central controller when looking for a maximum efficiency, when trying to maintain a maximum efficiency, when deciding to limit output power for some reason, e.g. failures or external instruction to do so, etc.

According to the present invention predetermined should be given a broad interpretation, meaning that it can easily be dynamic or configurable or changed by the next instruction; but at the time the central controller communicates a certain value to the DC/DC converter to use as a limit or aim or setting, it is predetermined by the central controller.

When said central controller CC is arranged to be able to selectively control, via said control inputs CI1, CI2, CIn, a local maximum power point tracking algorithm of each of at least two of said DC/DC converters DD1, DD2, DDn, an advantageous embodiment of the present invention is obtained.

According to an embodiment of the invention, the DC/DC converters carry out their individual power point tracking, but with the possibility for the central controller to force certain operational parameters, etc. This may be beneficial when the central controller has obtained knowledge e.g. from other DC/DC converters that a certain DC/DC converter may benefit from, or it may advantageously be used to set starting conditions or settings based on an overall system view.

When the power generation system comprises at least one measuring module MM arranged to determine at least one characteristic of said system intermediate output SIO, an advantageous embodiment of the present invention is obtained.

In order to facilitate the central controller in carrying out its refined control mechanism of controlling the DC/DC converters indirectly by controlling the system current, knowledge of the system current may be obtained by a measuring module. Other characteristics that a measuring module may determine in different embodiments of the present invention may comprise voltage, noise, variations, temperatures, illumination, etc. The measuring module may be located where most appropriate and it may be distributed to different locations.

When said central controller CC is arranged to receive one or more of said at least one characteristic from said at least one measuring module MM, an advantageous embodiment of the present invention is obtained.

When the power generation system comprises a system DC/DC converter SDD coupled to said system intermediate output SIO and providing a system output SO, an advantageous embodiment of the present invention is obtained.

According to the present invention the need to control e.g. voltage and current of the overall system output is decoupled from the need to control the intermediate system output by means of a system DC/DC converter.

When said central controller CC is arranged to be able to selectively set an input state of said system DC/DC converter SDD, an advantageous embodiment of the present invention is obtained.

According to the present invention, input state refers to characteristics or operational parameters related to or influencing the power input of the system DC/DC converter, i.e. in fact the intermediate system output voltage and current. Examples are given below. When the central controller is enabled to control these, it is in fact given a smart way to control the DC/DC converters despite, or in collaboration with, their autonomous maximum power point tracking

When said input state is selected from a list of at least one or more of
a state of seeking a predetermined input power,
a state of seeking a predetermined input current,
a state of seeking a predetermined input voltage, and
a state of seeking a predetermined input voltage and a predetermined input current,
   an advantageous embodiment of the present invention is obtained.

In particular the option to set the input current is very advantageous as it facilitates a high degree of control of the DC/DC converters in a series coupled PV module. On the other hand, the option to control input voltage is interesting for a parallel coupled system.

According to the present invention, predetermined should be given a broad interpretation, meaning that it can easily be dynamic or configurable or changed by the next instruction; but at the time the central controller communicates a certain value to the system DC/DC converter to use as a limit or aim or setting, it is predetermined by the central controller.

When said central controller CC is arranged to be able to selectively set a system output state of said system DC/DC converter SDD, said system output state being selected from a list of at least one or more of
a state of contributing power,
a state of not contributing power,
a state of seeking a predetermined output power,
a state of seeking a predetermined output current,
a state of seeking a predetermined output voltage,
a state of seeking a predetermined output pulse frequency, and
a state of seeking a predetermined output pulse duty cycle,
   or combinations thereof, an advantageous embodiment of the present invention is obtained.

According to the present invention, output state refers to characteristics or operational parameters related to or influencing the power output of the system DC/DC converter, i.e. the system output voltage and current.

According to the present invention, the central controller may shut the system output down by selecting the appropriate output state of the system DC/DC converter. This is advantageous for security reasons, e.g. during maintenance, as a problem with PV modules is that they typically generate power as soon as they are illuminated.

According to the present invention, predetermined should be given a broad interpretation, meaning that it can easily be dynamic or configurable or changed by the next instruction; but at the time the central controller communicates a certain value to the system DC/DC converter to use as an output limit or aim or setting, it is predetermined by the central controller.

When the power generation system comprises an inverter DA coupled to said system output SO and providing a system AC output SAO, an advantageous embodiment of the present invention is obtained.

Any type and configuration of inverter is within the scope of the present invention. The output of the inverter is preferably set to correspond to local electrical grid specifications, e.g. single phase with 230 V at 50 Hz, but any setting is within the scope of the present invention.

When said central controller CC is arranged to be able to selectively set an inverter output state of said inverter DA, said inverter output state being selected from a list of at least one or more of
a state of contributing power,
a state of not contributing power,
a state of seeking a predetermined output power,
a state of seeking a predetermined output current,
a state of seeking a predetermined output voltage,
a state of seeking a predetermined output frequency, and
a state of seeking a predetermined output phase,
   or combinations thereof, an advantageous embodiment of the present invention is obtained

According to the present invention, output state refers to characteristics or operational parameters related to or influencing the power output of the inverter, i.e. the system AC output voltage, current and other characteristics.

According to a preferred embodiment, any characteristics of the output of the inverter are subject to control, including user-controlled or variable settings. In this sense, predetermined means that it is not continuously fluctuating but not necessarily preset by the manufacturer either. It may e.g. be predetermined by hard wiring e.g. at the time of manufacture or mounting, or it may e.g. be predetermined by soft coding e.g. at the time of mounting or at any time desirable by use of a user interface. It may also be automatically predetermined by the central controller in an embodiment, where the central controller is provided with sufficient external information, to be able to determine the best or the required inverter output.

In a preferred embodiment, the inverter DA enables control of the input current, i.e. the current flowing through the DC/DC converters DD1, DD2, DDn. A suitable inverter DA may e.g. comprise a DC/DC boost converter followed by a step-down inverter. Other possible inverter configurations comprise half-bridge or full-bridge based inverters or any other inverter type.

When said predetermined output power, current, voltage, frequency and/or phase are variable, an advantageous embodiment of the present invention is obtained.

When said at least two DC/DC converters DD1, DD2, DDn each comprises a converter controller C1, C2, Cn arranged to be controlled via said control input CI1, CI2, CIn, an advantageous embodiment of the present invention is obtained.

The DC/DC converters each comprise a converter controller. Different embodiments of the present invention comprise different complexity of the converter controllers. In one embodiment the converter controllers are quite simple, and merely comprises components sufficient to drive a switch mode DC/DC converter according to settings, e.g. duty cycle settings, received from the central controller. In more complex embodiments the converter controllers comprise more components, e.g. so that they can derive the relevant duty cycle settings themselves from e.g. a current setting received from the central controller. In an even more complex, yet preferred embodiment the converter controllers comprise entirely self-contained maximum power point tracking mechanisms which can be controlled by the central controller, but which can also work by themselves under standard circumstances or in case of communication problems or sudden changes which the central controller may not be able to handle sufficiently quickly. According to the present invention, the converter controllers further comprise means for gathering data and communication with the central controller.

When said converter controllers C1, C2, Cn are powered from corresponding said power inputs PI1, PI2, PIn, an advantageous embodiment of the present invention is obtained.

According to the present invention, the converter controllers are supplied directly from their corresponding solar cells, so provided the solar cells are sufficiently illuminated there will be power for the converter controller to communicate with the central controller, etc.

When said central controller CC comprises a processor for carrying out a maximum power point tracking algorithm for each of said at least two DC/DC converters DD1, DD2, DDn in turn via said control inputs CI1, CI2, CIn, an advantageous embodiment of the present invention is obtained.

According to an embodiment of the present invention, the maximum power point tracking is carried out by the central controller which is thereby able to include more parameters in the algorithm, e.g. measurements from central connections such as the overall output or inverter input, or external control values. In an advanced embodiment of the present invention the central controller is able to use information gathered from other DC/DC converters in the setting of the power point in a specific DC/DC converter. This ability can e.g. be used for predicting shadows as these will typically drift over a solar panel during the day or a few hours, or it can be used to improve the initialization of the maximum power point algorithm for solar cells close to or from the same panel as solar cells for which the tracking has already been carried out, as it is fair to assume that adjacent solar cells have approximately the same power point, at least if due consideration of known or experienced physical differences such as purity and nominal efficiency is incorporated. Moreover, the central controller is in the present invention able to perform a kind of overall maximum power point tracking of the accumulated voltage or current, and use this information for setting the desired common voltage or current of the individual DC/DC converters.

According to the present invention the term in turn is to be interpreted in a broad sense including any scheme of distributing the processing power of the central controller among the individual DC/DC converters. In a simple, yet efficient, scheme the central controller starts with DC/DC converter number 1, finds its maximum power point, sets its converter controller accordingly, and then moves on to DC/DC converter number 2 and so forth until all DC/DC converters have been set. Then it either starts over with converter number 1 again immediately, or it pauses for a predetermined time, e.g. 1 minute or 1 second, or a variable amount of time depending on the speed of change experienced over the last few circles or set by a user. In more complex schemes within the scope of the present invention, the central controller carries out the maximum power point tracking algorithm more often for DC/DC converters which are prone to faster changes than other, e.g. according to the controller's experience, e.g. converters associated with solar cells in the bottom of the module where items on the ground or sand or snow disturbs the light more often than in the top. In an even more complex scheme the tracking algorithm is divided into separate parts, where the first part, e.g. a coarse tracking, is first carried out for all converters in turn, and then a further part, e.g. a fine tracking, is then carried out for all converters in turn.

According to the present invention, the central controller, and/or the converter controllers for embodiments with local power point tracking, may comprise different maximum power point tracking algorithms to choose from in different situations, or at predetermined times. This could e.g. be coarse and fine tracking algorithms as mentioned above or it could be algorithms optimized for fast changes, slow changes, huge differences between solar cells, small differences between solar cells, etc. The different maximum power point tracking algorithm could also be differently optimized with regard to electro magnetic interference EMI and other noise issues, processor power consumption, etc. For example, in a preferred embodiment, efficiency optimized fast algorithms driving the processor at maximum performance level may be used for initialization tracking and when great changes in illumination occur, e.g. when the sun goes in, whereas maintenance optimized slow algorithms driving the processor at a lower performance level may be used in general to minimize the power consumption of the controller and also reduce the heat dissipation.

According to the present invention, the central controller may also use any waiting time in the algorithms to move on with a further converter and carry out a bit of an algorithm there in the meantime. Thus in algorithms involving the setting of the converter controller and waiting a certain time before new measurements are collected, the central controller may do the setting for several converter controllers first and then go back and collect measurements. In a preferred embodiment this scheme is further optimized by having the converter controller locally collect data or even carry out a few steps of an algorithm autonomously and then await instructions for sending back collected results from the steps carried out.

When said carrying out a maximum power point tracking algorithm for each of said at least two DC/DC converters DD1, DD2, DDn in turn, comprises repeatedly carrying out a maximum power point tracking algorithm at a predetermined interval, an advantageous embodiment of the present invention is obtained.

When said converter controller C1, C2, Cn of each of said at least two DC/DC converters DD1, DD2, DDn comprises a processor for carrying out a local maximum power point tracking algorithm, an advantageous embodiment of the present invention is obtained.

According to a preferred embodiment of the present invention, the DC/DC converters are autonomous in the sense that they are each able to track their own cell's maximum power point, which is very significant for the overall system efficiency.

When said at least two DC/DC converters DD1, DD2, DDn each comprises a data output DO1, DO2, DOn, an advantageous embodiment of the present invention is obtained.

In a preferred embodiment of the present invention, the DC/DC converters transmit information to the central controller or the other DC/DC converters. The information may e.g. comprise solar cell output data, solar cell temperature, switch mode converter efficiency, converter output voltage, etc.

When said data output DO1, DO2, DOn is comprised by said control input CI1, CI2, CIn to form an input/output device, an advantageous embodiment of the present invention is obtained.

When said central controller CC is arranged to receive information about the power input PI1, PI2, PIn values and/or power output PO1, PO2, POn values of each of said at least two DC/DC converters DD1, DD2, DDn via said data outputs DO1, DO2, DOn, an advantageous embodiment of the present invention is obtained.

According to a preferred embodiment of the present invention the central controller may use the information, for example to determine if a DC/DC converter should be shut down or when to set an appropriate predetermined value for the common current.

When said central controller CC is arranged to receive information from said inverter DA, an advantageous embodiment of the present invention is obtained.

When the power generation system comprises a data interface DI for transmitting information to an external recipient and/or for receiving control data from an external source, an advantageous embodiment of the present invention is obtained.

According to the present invention any type of external recipient or external source is within the scope of the present invention. In a preferred embodiment the external recipient of data comprises a human interface means for displaying the data and logging means, e.g. a database, for storing raw or processed data. In a preferred embodiment the external source comprises a human interface means for allowing a user to input control parameters or select from a set for predetermined user variables.

The present invention further relates to a method of operating a power generation system PGS comprising a plurality of DC/DC converters DD1, DD2, DDn each connected to at least one solar cell SC1, SC2, SCn and having their power outputs PO1, PO2, POn coupled in series or in parallel to provide an accumulated system output voltage or an accumulated system output current, respectively, at a system intermediate output SIO, characterised in that a central controller CC selectively sets an output state of each of at least two of said DC/DC converters DD1, DD2, DDn.

According to the present invention an advantageous way of operating a PV module is provided because the method facilitates control in both details and overall, which enables an optimal overall system performance better than obtainable by either local power point tracking or central power point tracking

According to the present invention, output state refers to characteristics or operational parameters related to or influencing the power output of the DC/DC converter. Examples are given below.

When said output state is selected from a list of at least
a state of contributing power and
a state of not contributing power,
   an advantageous embodiment of the present invention is obtained.

According to the present invention, an advantageous control possibility for the central controller CC striving to achieve optimal system efficiency lies in turning specific DC/DC converters off when it can be determined that they actually drag the system down rather than contribute.

When said output state is selected from a list of at least one or more of
a state of seeking a predetermined output power,
a state of seeking a predetermined output current,
a state of seeking a predetermined output voltage, and
a state of seeking a predetermined output voltage and a predetermined output current,
   an advantageous embodiment of the present invention is obtained.

According to the present invention, the central controller preferably has other control possibilities also, as mentioned above. The different settings may be used by the central controller when looking for a maximum efficiency, when trying to maintain a maximum efficiency, when deciding to limit output power for some reason, e.g. failures or external instruction to do so, etc.

According to the present invention, predetermined should be given a broad interpretation, meaning that it can easily be dynamic or configurable or changed by the next instruction; but at the time the central controller communicates a certain value to the DC/DC converter to use as a limit or aim or setting, it is predetermined by the central controller.

When said DC/DC converters DD1, DD2, DDn each carries out a local maximum power point tracking algorithm individually, an advantageous embodiment of the present invention is obtained.

According to an embodiment of the invention, the DC/DC converters carry out their individual power point tracking, but with the possibility for the central controller to force certain operational parameters etc. This may be beneficial when the central controller has obtained knowledge e.g. from other DC/DC converters that a certain DC/DC converter may benefit from, or it may advantageously be used to set starting conditions or settings based on an overall system view.

When said central controller CC sets said output state at least partly on the basis of least one characteristic of a system intermediate output SIO, e.g. accumulated system output voltage or system output current, an advantageous embodiment of the present invention is obtained.

In order to facilitate the central controller in carrying out the advantageous method of the present invention of controlling the DC/DC converters indirectly by controlling the system current, knowledge of the system current and other characteristics, e.g. voltage, noise, variations, temperatures, illumination, etc., may be very significant.

When a system DC/DC conversion is carried out on said system intermediate output SIO to establish a system output SO, an advantageous embodiment of the present invention is obtained.

Thereby, according to the present invention, is the need to control e.g. voltage and current of the overall system output decoupled from the need to control the intermediate system output.

When said central controller CC controls said system DC/DC conversion in order to seek at least one of a predetermined input power, a predetermined input current and a predetermined input voltage, an advantageous embodiment of the present invention is obtained.

When the central controller is enabled to control these, it is in fact given a smart way to control the DC/DC converters despite, or in collaboration with, their autonomous maximum power point tracking

In particular the option to set the input current is very advantageous as it facilitates a high degree of control of the DC/DC converters in a series coupled PV module. On the other hand, the option to control input voltage is interesting for a parallel coupled system.

According to the present invention, predetermined should be given a broad interpretation, meaning that it can easily be dynamic or configurable or changed by the next instruction; but at the time the central controller communicates a certain value to the system DC/DC converter to use as a limit or aim or setting, it is predetermined by the central controller.

When said system DC/DC conversion is controlled by said central controller CC in order to control said accumulated system output voltage or said accumulated system output current and/or associated current or voltage, an advantageous embodiment of the present invention is obtained.

When said central controller CC controls said system DC/DC conversion in order to seek one or more of
a state of contributing power,
a state of not contributing power,
a predetermined output power,
a predetermined output current,
a predetermined output voltage,
a predetermined output pulse frequency, and
a predetermined output pulse duty cycle,
   an advantageous embodiment of the present invention is obtained.

According to the present invention, the central controller may e.g. shut the system output completely down. This is advantageous for security reasons, e.g. during maintenance, as a problem with PV modules is that they typically generate power as soon as they are illuminated.

According to the present invention, predetermined should be given a broad interpretation, meaning that it can easily be dynamic or configurable or changed by the next instruction; but at the time the central controller communicates a certain value to the system DC/DC converter to use as an output limit or aim or setting, it is predetermined by the central controller.

When a DC/AC conversion is carried out on said system output SO to establish a system AC output SAO, an advantageous embodiment of the present invention is obtained.

Any type and configuration of DC/AC conversion is within the scope of the present invention. The system AC output is preferably established according to local electrical grid specifications, e.g. single phase with 230 V at 50 Hz, but any setting is within the scope of the present invention.

When said central controller CC controls said DC/AC conversion in order to seek one or more of
a state of contributing power,
a state of not contributing power,
a predetermined output power,
a predetermined output current,
a predetermined output voltage,
a predetermined output frequency, and
a predetermined output phase,
   an advantageous embodiment of the present invention is obtained.

According to a preferred embodiment, any characteristics of the DC/AC conversion are subject to control, including user-controlled or variable settings. In this sense, predetermined means that it is not continuously fluctuating but not necessarily preset by the manufacturer either. It may e.g. be predetermined by hard wiring e.g. at the time of manufacture or mounting, or it may e.g. be predetermined by soft coding e.g. at the time of mounting or at any time desirable by use of a user interface. It may also be automatically predetermined by the central controller in an embodiment where the central controller is provided with sufficient external information to be able to determine the best, or the required inverter output.

In a preferred embodiment, the DC/AC conversion enables control of the input current, i.e. the current flowing through the DC/DC converters DD1, DD2, DDn. A suitable DC/AC conversion may e.g. be implemented as a DC/DC boost converter followed by an inverter. Possible inverter configurations comprise half-bridge or full-bridge based inverters or any other inverter type.

When said at least two DC/DC converters comprises converter controllers C1, C2, Cn that are powered from corresponding said connected solar cells SC1, SC2, SCn, an advantageous embodiment of the present invention is obtained.

The DC/DC converters each comprise a converter controller. In a preferred embodiment the converter controllers comprise entirely self-contained maximum power point tracking mechanisms which can be controlled by the central controller, but which are usually working by themselves under standard circumstances or in case of communication problems or sudden changes which the central controller may not be able to handle sufficiently quickly. According to the present invention, the converter controllers further comprise means for gathering data and communication with the central controller.

According to a preferred embodiment of the present invention, the converter controllers are supplied directly from their corresponding solar cells, so provided the solar cells are sufficiently illuminated there will be power for the converter controller to communicate with the central controller, etc.

When said central controller CC carries out a maximum power point tracking algorithm for each of said at least two DC/DC converters DD1, DD2, DDn, an advantageous embodiment of the present invention is obtained.

According to an embodiment of the present invention, the maximum power point tracking is carried out by the central controller which is thereby able to include more parameters in the algorithm, e.g. measurements from central connections such as the overall output or inverter input, or external control values. In an advanced embodiment of the present invention the central controller is able to use information gathered from other DC/DC converters in the setting of the power point in a specific DC/DC converter. When the maximum power point tracking algorithm is carried out for each DC/DC converter DD1, DD2, DDn in turn and repeatedly at a predetermined interval, an advantageous embodiment of the present invention is obtained.

When said central controller CC receives information about input, output and/or internal values of at least two of said DC/DC converters DD1, DD2, DDn via data outputs DO1, DO2, DOn, an advantageous embodiment of the present invention is obtained.

According to a preferred embodiment of the present invention the central controller may use the information for example to determine if a DC/DC converter should be shut down, or when to set an appropriate predetermined value for the common current.

When said central controller CC receives information about input, output and/or intermediate values in relation to said DC/AC conversion, an advantageous embodiment of the present invention is obtained.

When a data interface DI is provided for transmitting information to an external recipient and/or for receiving control data from an external source, an advantageous embodiment of the present invention is obtained.

According to the present invention any type of external recipient or external source is within the scope of the present invention. In a preferred embodiment the external recipient of data comprises a human interface means for displaying the data and logging means, e.g. a database, for storing raw or processed data. In a preferred embodiment the external source comprises a human interface means for allowing a user to input control parameters or select from a set for predetermined user variables.

When said DC/DC converters DD1, DD2, DDn automatically change their output state to a state of not contributing power if they do not receive a communication from said central controller for a predetermined time, and advantageous embodiment of the present invention is obtained.

According to the present invention, the system may thereby shut itself down when the communication ceases. It is thereby impossible for a PV module utilizing the method of the present invention to provide any power at its output unless the central controller is up and running In an embodiment of the present invention the central controller is powered by external means or has a control input so that it is not able to start the DC/DC converters before the PV module is connected to the power grid or other load.

When said central controller CC operates according to an algorithm that involves setting an individual of said DC/DC converters DD1, DD2, DDn to a state of not contributing power and evaluating if the overall system performance is affected positively, whereby the respective DC/DC converter is left with that setting for a predetermined time, or negatively, whereby the respective DC/DC converter is set to an output state that contributes power, an advantageous embodiment of the present invention is obtained.

According to a preferred embodiment of the present invention, the central controller may try once in a while to shut different DC/DC converters down and see what happens. If the overall system efficiency is improved thereby, the particular DC/DC converter should be left in that state for a certain time, until it may be that the problems causing it to drag the system efficiency down has disappeared.

### THE DRAWINGS

The invention will in the following be described with reference to the drawings where

FIG. 1 illustrates a power generation system according to an embodiment of a the present invention,

FIG. 2 illustrates a power generation system comprising a measuring module according to a second embodiment of the present invention,

FIG. 3 illustrates a power generation system comprising a system DC/DC converter according to a third embodiment of the present invention,

FIG. 4 illustrates a power generation system comprising an inverter according to a fourth embodiment of the present invention,

FIG. 5 illustrates a power generation system comprising DC/DC converters coupled in parallel according to a fifth embodiment of the present invention,

FIG. 6 illustrates a DC/DC converter in more detail according to an embodiment of the present invention, and

FIG. 7 illustrates a DC/DC converter in more detail according to an embodiment of the present invention.

### DETAILED DESCRIPTION

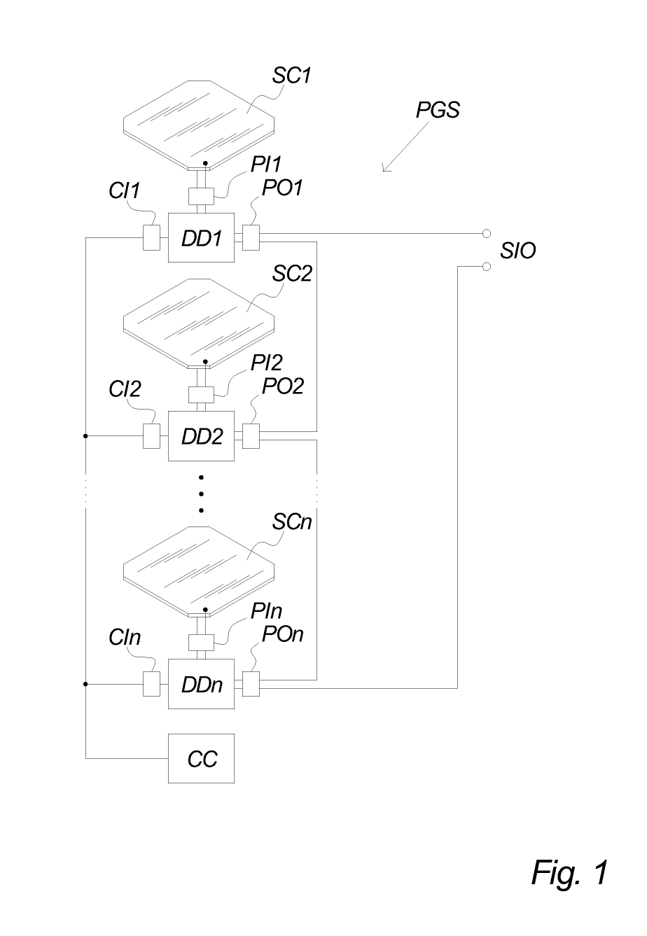

FIG. 1 illustrates a power generation system PGS according to an embodiment of the present invention. It comprises a number of solar cells SC1, SC2, SCn. Any type of solar cells can be used with the present invention, e.g. bulk- or wafer-based, thin film, or nanocrystalline solar cells and based on any materials, e.g. silicon, cadmium telluride, copper indium selenide, gallium arsenide multijunction, ruthenium metalorganic dye or other light absorbing dyes, or organic or polymer solar cells. The solar cells SC1, SC2, SCn may be divided into sub-cells of which a number may be coupled in series in order to generate a higher combined voltage where appropriate.

The power generation system further comprises a number of DC/DC converters DD1, DD2, DDn connected to the solar cells via power inputs PI1, PI2, PIn. Preferably each DC/DC converter is associated with only one solar cell, in order to maximise the efficiency of each individual solar cell, but embodiment with two or more solar cells or sub-cells connected in series or parallel for each DC/DC converter are also within the scope of the present invention. In a preferred embodiment the type and/or number of solar cells connected to a DC/DC converter is arranged so that a voltage sufficient for driving the electronics comprised by the DC/DC converter is produced, possibly by application of a step-up converter. In an alternative embodiment the DC/DC converters are driven by an external power supply, or e.g. from the accumulated system output voltage.

In an embodiment of the invention, the solar cells are silicon cells and each solar cell is divided into 8 sub-cells. Each DC/DC converter is served by 12 sub-cells, i.e. one and a half solar cell, connected in series, thus generating an accumulated voltage of approximately 6.0 V. This voltage makes the implementation of an efficient and suitable converter much simpler, as compared to the task of implementing a converter working on e.g. 0.5 V. Moreover, by choosing a different number of cell divisions and sub-cells serving each DC/DC converter, in this example 8 and 12 respectively, the maximum current to be handled by each DC/DC converter can be controlled.

Each DC/DC converter also comprises a power output PO1, PO2, POn. The power outputs are in this embodiment connected in series, so as to establish an accumulated system DC output voltage at a system intermediate output SIO. By series connecting the converters, their voltages are accumulated, but their common current will approach the lowest current of any of the DC/DC converter power outputs. Hence is desired equal current output of all the converters. The DC/DC converters DD1, DD2, DDn achieve this by converting the DC voltage and current produced by the associated solar cells into the desired DC current and an according voltage in order to transfer as much of the power at the power inputs PI1, PI2, PIn as possible.

Several implementations of high-efficient, controllable, typically switch-mode, DC/DC converters suitable for use with the present invention are known by the skilled person, e.g. buck, boost, buck-boost, Cuk, flyback and SEPIC converters. Examples are described in WO 2006/005125 A1, disclosing different buck-type DC/DC converters and different implementations of current filtering means, hereby incorporated by reference, WO 2004/001942 A1, disclosing DC/DC converters with either an H-bridge or a push-pull stage, hereby incorporated by reference, US 2006/0132102 A1, disclosing in FIG. 10A-14B and FIG. 18-19 several types of DC/DC converters, hereby incorporated by reference, WO 2004/006342 A1, disclosing in FIGS. 8, 13 and 19 different suitable DC/DC converters, hereby incorporated by reference, and the paper “Cascaded DC-DC Converter Connection of Photovoltaic Modules” by Geoffrey R. Walker and Paul C. Sernia, published in IEEE Transactions on Power Electronics, Vol. 19, No. 4, July 2004, disclosing different types of DC/DC converters, hereby incorporated by reference.

The embodiment of the present invention in FIG. 1 further comprises a control input CI1, CI2, CIn for each DC/DC converter DD1, DD2, DDn. These control inputs are connected to a central controller CC. Due to the possibly huge differences in potential between the central controller and each of the DC/DC converters, a preferred embodiment facilitates galvanic separation in relation to each control input CI1, CI2, CIn. The galvanic separation may be implemented by means of any known galvanic separation means, e.g. transformers, optocouplers or capacitors. In a preferred embodiment of the present invention, the control signal from the central controller comprises a synchronization signal, e.g. a clock signal, which the DC/DC converters may use to clock their switching stages possibly after performing an appropriate clock division. The synchronisation signal may in an alternative embodiment, however, also be provided to the converters by separate wiring.

In a preferred embodiment, the DC/DC converters are also able to communicate with each other through the control inputs CI1, CI2, CIn.

Preferably, each DC/DC converter comprises means for carrying out a maximum power point tracking algorithm locally. The central controller CC then controls the overall performance by controlling the overall current flowing through each converter (in a serial coupled system). In an alternative embodiment the central controller CC may in addition or instead force the DC/DC converters to use certain operational parameters, preferably on an individual basis. In yet an alternative embodiment, instead of having each DC/DC converter comprise an autonomously working maximum power point tracking mechanism, the present invention facilitates a common maximum power point tracking mechanism implemented in the central controller CC, thereby enabling gathering and use of system information in the control mechanism of the individual converters, and reducing the requirements to the individual converters. In such an embodiment of the invention, the central controller CC carries out a maximum power point tracking algorithm for each DC/DC converter individually in turn. Hence, for a PV module with e.g. 72 converters, the central controller carries out a maximum power point tracking algorithm 72 times, one for each converter, and then starts over with the first converter again. During the time a DC/DC converter is not subject to maximum power point tracking from the central controller, e.g. when other converters are being tracked, the converter preferably carries on with the settings set by the central controller during the last tracking session. In a preferred embodiment, the DC/DC converters each comprise a local maximum power point tracking mechanism, anyway, which is arranged to continue the power point tracking between the tracking sessions by the central controller, preferably within certain ranges set by the central controller.

The local maximum power point tracking algorithms employed by each DC/DC converter in a preferred embodiment of the invention may in principle comprise any maximum power point tracking algorithm suitable for use with solar cells and switch mode DC/DC converters. However, a list of preferred methods for implementation as a maximum power point tracking algorithm for use with the present invention comprises the Perturbation and Observation method as the most preferred, but also the Improved Perturbation and Observation method, the Incremental Conductance method, the Load Current or Load Voltage Maximization method, and the Ripple Correlation Control method. Other usable methods comprise, but are not limited to, the Hill Climbing method, the AP Pertubation and Observation method, the Fractional Open-Circuit Voltage method, the Fractional Short-Circuit Current method, the Current Sweep method, the dP/dV or dP/dI Feedback method, and the Parasitic Capacitance method. Also algorithms based on fuzzy logic or neural network, as well as algorithms combining two or more methods, e.g. for different circumstances, are within the scope of the present invention. Documentation for all these methods are available in the prior art to the skilled person, for example are several of the methods described in US 2006/0132102 A1, hereby incorporated by reference.

In an embodiment of the present invention, each DC/DC converter may comprise a number of low-power DC/DC converters coupled in parallel, each facilitating their own controller and switch mode converter. This is beneficial when the solar cells are able to generate relatively high power, as several low power, high efficiency DC/DC converters may easily be cheaper than a single high power, high efficiency DC/DC converter. In this embodiment, the parallel DC/DC converters serving the same solar cell should be able to communicate with each other.

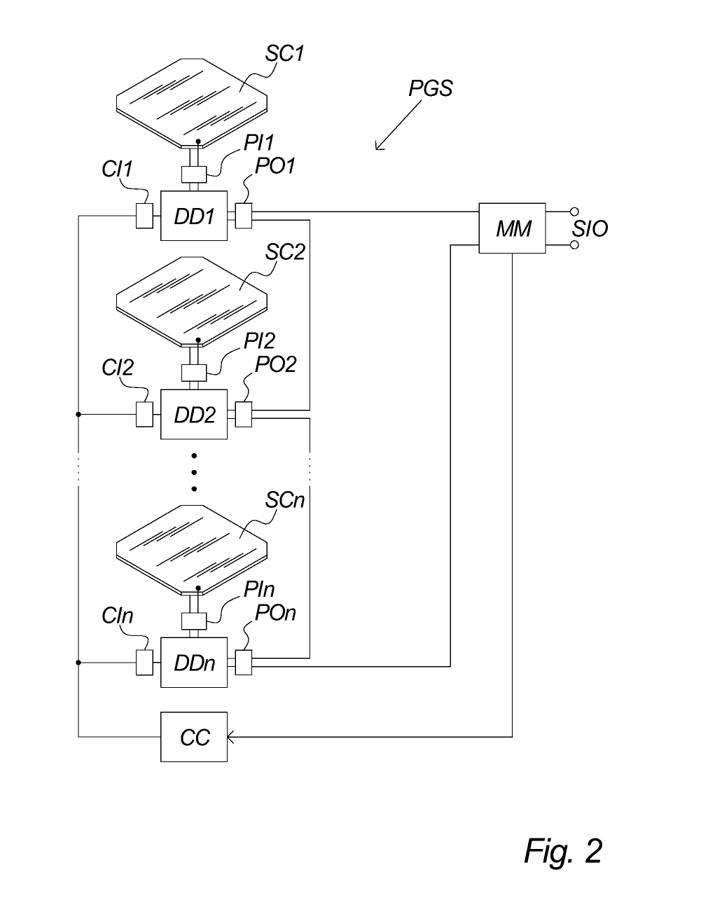

FIG. 2 illustrates an embodiment of a power generation system PGS according to the present invention in more detail and including more components. The main components correspond to the embodiment of FIG. 1 described above. The embodiment of FIG. 2 further comprises a measuring module MM for monitoring and determining characteristics of the system performance, e.g. at the system intermediate output SIO, and transmit this information to the central controller CC. The measuring module MM may in a preferred embodiment determine the voltage and current at the system intermediate output for the central controller to use as feedback in order to discover the effect of different settings of the individual DC/DC converters and in that way perform a kind of accumulated system maximum power point tracking of the combined output of all DC/DC converters. In certain cases, for example, the accumulated system power at the system intermediate output SIO may be improved by means of the central controller ordering a specific DC/DC converter to stop contributing because it otherwise drags the whole system down. The algorithm of the central controller may then cause the DC/DC converter to start contributing for a short time at certain intervals to discover if the system is still best off by having that converter not contributing. In order to know the current efficiency and determine if efficiency is improving or decreasing by certain measures, the central controller benefits from the characteristics established by the measurement module.

Any suitable implementation of the measurement module is within the scope of the present invention, e.g. any suitable method of measuring and representing current and voltage. Also a distributed measurement module, where e.g. the voltage or current measurement or both is taking place at a different physical location than the system intermediate output SIO is within the scope of the invention. Such a different physical location may e.g. be within one of the DC/DC converters, e.g. the one located nearest to the central controller, as the DC/DC converters preferably comprise a current measuring means anyway.

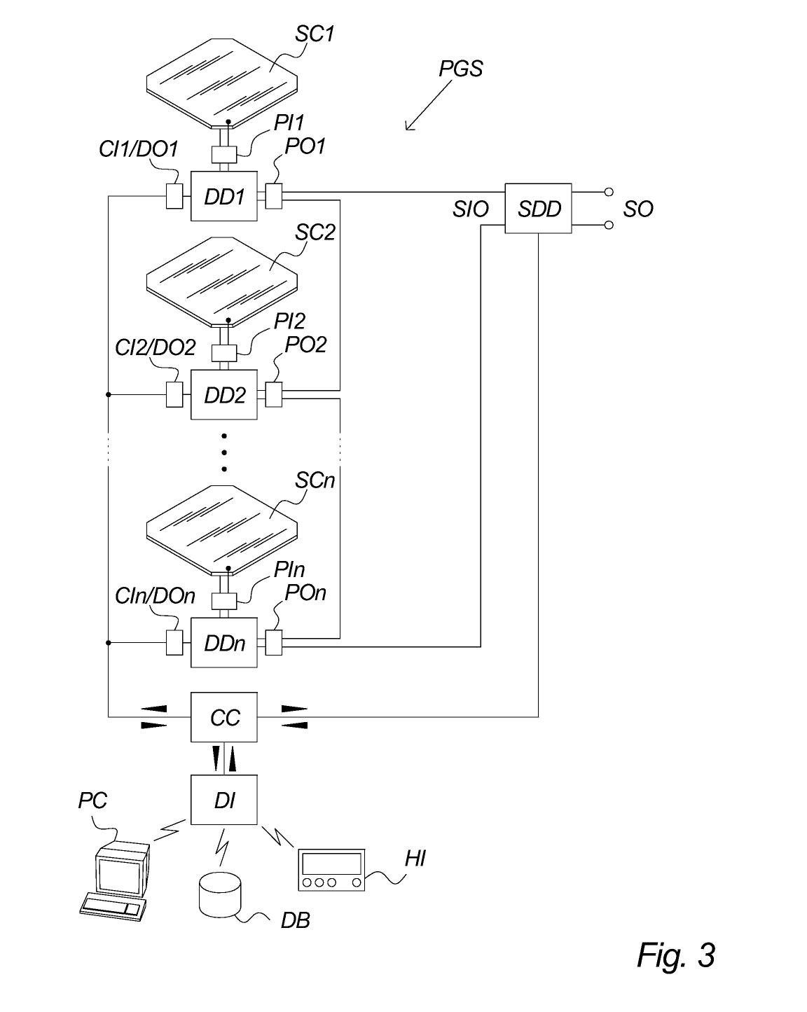

FIG. 3 illustrates an embodiment of a power generation system PGS according to the present invention in more detail and including more components. The main components correspond to the embodiments of FIGS. 1 and 2 described above. The embodiment of FIG. 3 comprises a system DC/DC converter SDD, which converts the accumulated voltage and associated current at the system intermediate output SIO into a system voltage and associated current at a system output SO. The system DC/DC converter is preferably a controllable DC/DC converter, preferably a DC/DC boost converter. The central controller is connected to a control input of the system DC/DC converter SDD in order to be able to control its operational parameters and states. In a preferred embodiment the central controller uses the system DC/DC converter SDD to force a predetermined current through the DC/DC converters DD1, DD2, DDn, thereby giving the central controller a powerful control means which often work better than controlling each DC/DC converter individually.

The connection between the central controller and the system DC/DC converter SDD also allows the central controller in a preferred embodiment to control the output of the system DC/DC converter, e.g. whether or not there should be an output voltage at all, or what the voltage and current should be.

In FIG. 3 the measuring module MM of FIG. 2 is substituted with the system DC/DC converter SDD, which may include the measuring functionality and communicate the determined characteristics back to the central controller CC, hence the two-way connection. The DC/DC converter may be arranged to determine characteristics corresponding to the characteristics determined by the measuring module, e.g. relating to the accumulated system DC output voltage, the current thereof, or e.g. the temperature of the PV module, etc. In an alternative embodiment, the measuring module MM may also be implemented in addition to the system DC/DC converter, e.g. when it is distributed or located differently. In a preferred embodiment some characteristics are determined within the system DC/DC converter SDD and some characteristics are determined elsewhere by means of distributed measuring modules.

The current sensing and controllable system DC/DC converter SDD of the embodiment of FIG. 3 amounts to a strong and advantageous mechanism because the central controller is now able to both know and control the system current and thereby, in turn, the several DC/DC converters.

In an embodiment of the invention, the DC/DC converters DD1, DD2, DDn comprise a data output DO1, DO2, DOn, preferably comprised by the control inputs CI1, CI2, CIn. Thereby the central controller CC is able to receive information also from each DC/DC converter, e.g. relating to the voltage or current at the power inputs PI1, PI2, PIn or the power outputs PO1, PO2, POn. Further relevant information may comprise e.g. the temperature at each solar cell, etc. The central controller may use the information from the individual DC/DC converters and the system DC/DC converter in order to optimize the power points at which the individual DC/DC converters are driven, and the overall system efficiency.

In an embodiment of the invention, the power generation system further comprises a data interface DI for transmitting or receiving data from external sources, e.g. a computer PC, a database DB or a human interface HI, e.g. a display with control buttons. The information transmitted to external recipients may comprise status of the overall system and of the individual DC/DC converters or solar cells, e.g. regarding shadowing or damages. The information may comprise a history, or a history may be maintained at the external recipient, e.g. a database. The information received from the external sources, e.g. a computer or a command panel, may comprise commands to shut down the system, perform maintenance or self-test procedures, set operational parameters, e.g. the desired output voltage and/or frequency, retrieve specific information, etc. The data interface may also be able to communicate with other PV modules. The data interface DI may communicate with external sources by means of any suitable communication interface, e.g. data communication technology, computer network technology including Internet technology, Bluetooth, etc.

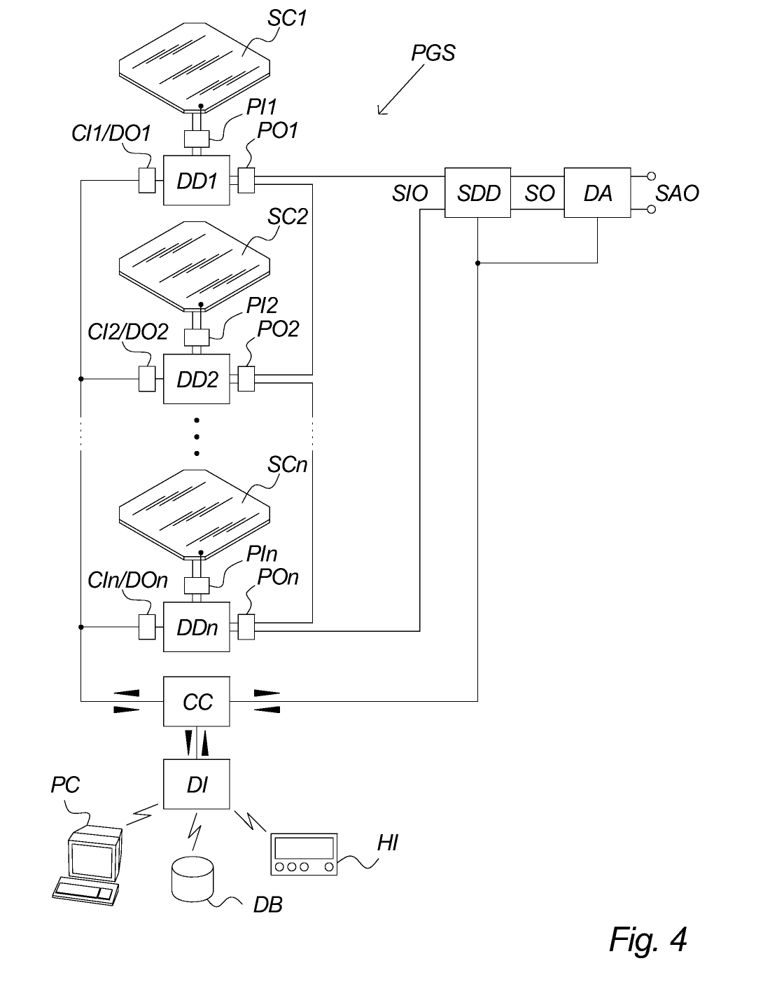

FIG. 4 illustrates an embodiment of a power generation system PGS according to the present invention in more detail and including more components. The main components correspond to the embodiments of FIG. 1-3 described above. The embodiment of FIG. 4 comprises a DC/AC inverter DA, preferably a step-down inverter, which converts the system output SO, i.e. the output of the system DC/DC converter SDD, into a system AC output SAO, preferably at a voltage and frequency corresponding to the local power grid specifications, e.g. 110V at 60 Hz or 230V at 50Hz. In an alternative embodiment, the inverter DA may be variable and output a user-controllable voltage and/or frequency, e.g. for controlling electric equipment. The central controller CC is in the embodiment of FIG. 4 connected to the inverter as well as the system DC/DC converter SDD. According to an embodiment of the invention the central controller also controls the DC/AC inverter DA, e.g. in order to shut down the inverter so that no system alternating current is produced at the output terminals, e.g. for safety reasons, or to control a variable output inverter.

In an alternative embodiment of the present invention, the combination of a system DC/DC converter SDD and the inverter DA is substituted by only an inverter which may, however, comprise DC/DC converter technology. In a preferred embodiment the input current of the block that is coupled to the system intermediate output should be controllable in order to be able to optimize system efficiency beyond the local maximum power point tracking carried out in each DC/DC converter.

According to an embodiment of the invention, the central controller may receive information from the inverter DA, e.g. relating to the voltage, current, frequency, etc, of the system AC output SAO. As described above with reference to FIG. 3 for the system DC/DC converter, the inverter DA may also comprise part of a measuring module MM, or the measuring module may be distributed among different blocks or located elsewhere.

As in FIG. 3, the embodiment of FIG. 4 also comprises a data interface DI. In an embodiment of the invention is exploited that it is commonly known to establish a computer network connection via a power grid, sometimes referred to as power line communication or broadband over power lines. A power generation system according to the present invention may therefore be able to communicate with external devices via the grid connection from the inverter, i.e. without need for separate network cables, etc. The communication from the data interface DI to the grid could be made via the central controller and the control connection between the central controller and the inverter, or a separate connection could be made directly from the data interface to a grid modem at the inverter output.

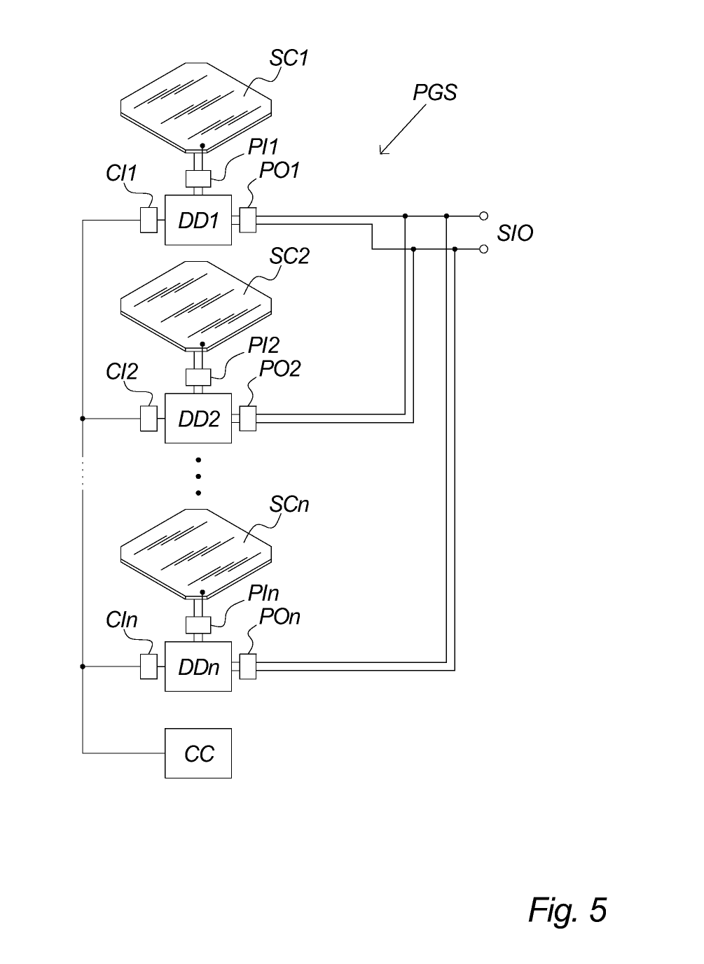

FIG. 5 illustrates an embodiment of the present invention with the same elements as the embodiment described with reference to FIG. 1, but where the power outputs PO1, PO2, POn are coupled in parallel as contrary to the series connections illustrated in FIG. 1-4. By connecting the converters in parallel, their currents are accumulated, but their common voltage will approach the lowest voltage of any of the DC/DC converter power outputs. Hence is desired equal voltage output of all the converters. The DC/DC converters DD1, DD2, DDn achieve this by converting the DC voltage and current produced by the associated solar cells into the desired DC voltage and an according current, in order to transfer as much of the power at the power inputs PI1, PI2, PIn as possible. This can be done by any of the DC/DC converter types mentioned above regarding FIG. 1.

The rest of the components correspond to the similar components of the embodiment of FIG. 1. In particular the embodiment of FIG. 5 also comprises a central controller CC which is able to control the output state and operational parameters of the DC/DC converters and thereby control the overall system efficiency.

In general, the main tasks for the central controller in a preferred embodiment comprise:
host the communication, i.e. negotiating and naming clients, e.g. the DC/DC converters, the measuring module, the system DC/DC converter, the inverter, the data interface, etc.,
provide or control keep-alive signals and synchronization signals; the DC/DC converters should shut down if they do not receive communications from the central controller for a predetermined time,
control the start-up of a PV module, e.g. by instructing the several DC/DC converters to start sequentially or in groups; all DC/DC converters should not start simultaneously,
monitor and only rarely be active as long as the PV module operates normally under average circumstances,
control the system current or voltage, respectively,
perform system efficiency tests at predetermined intervals or when it seems appropriate or necessary, e.g. by shutting a specific DC/DC converter down and see how the system react, or set operation conditions for a DC/DC converter, the system DC/DC converter, etc.; in particular at low production times or in case of failures can it be beneficial for the system efficiency to shut one or more converters down, as the rest may work better then, and
handle requests or instructions from the data interface, e.g. user inputs, and provide a selection of data to the data interface, e.g. for output on a display or for storing in a database.

It is noted that any subset of the above tasks, any combination with additional tasks, and any distribution of tasks to a plurality of controllers are within the scope of the present invention.

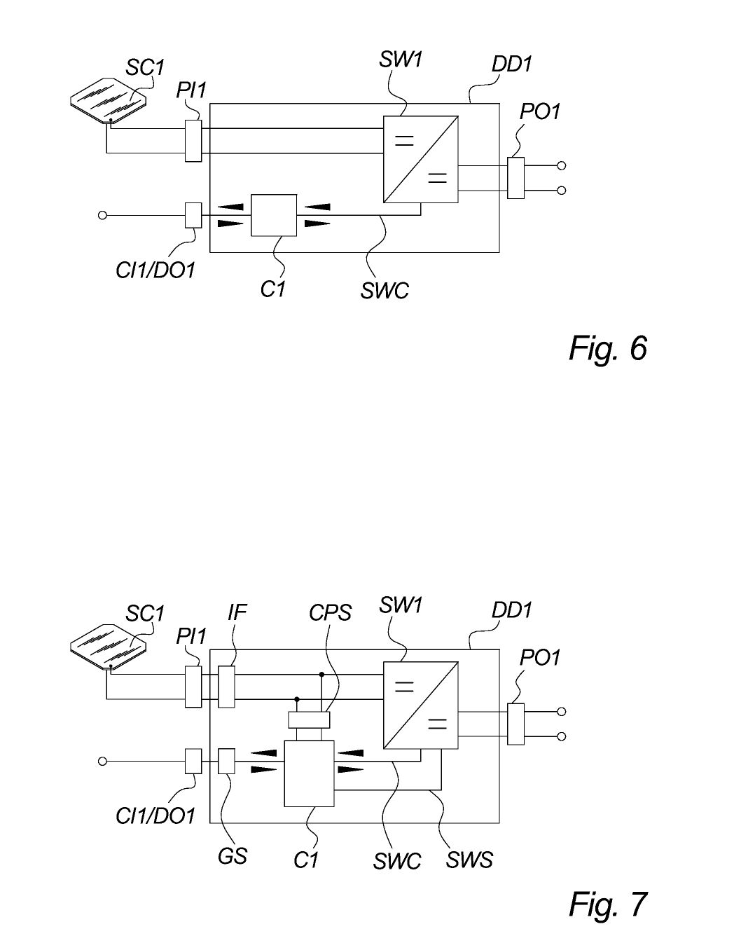

FIG. 6 illustrates a principle embodiment of a DC/DC converter DD1 according to the present invention. The converter DD1 comprises a power input PI1 which is coupled to a solar cell SC1 or an array of solar cells. A switch mode converter SW1 is provided as the core DC/DC conversion element and receives a voltage and current from the solar cell SC1 via the power input PI1, which it converts into a typically different voltage and current to be provided at a power output PO1. The switch mode converter SW1 is by means of a switch mode converter control signal SWC controlled by a converter controller C1, which is also coupled to a control input CI1 and a data output DO1, preferably implemented as a single input/output device. The external couplings of the power output PO1 and the control input CI1/data output DO1 are described above with reference to FIGS. 1 to 5.

In a preferred embodiment the switch mode converter SW1 is implemented as a buck-type converter with controllable working conditions, e.g. duty cycle and current or voltage.

In a preferred embodiment the converter controller C1 drives the switch mode converter SW1 according to a local power point tracking algorithm, e.g. one of the algorithms described above with reference to FIG. 1. Hence, the overall control by the central controller CC is in practice carried out by controlling the overall current (in a serial connected system) and letting the local converter controllers adapt to this, and provide maximum power according to local power point tracking algorithms. In a preferred embodiment, the central controller thus does not need to control operational parameters of each switch mode converter separately. However, it may be able to do so in an alternative embodiment. In an alternative embodiment, the converter controller C1 drives the switch mode converter SW1 according to the settings received from the central controller CC, e.g. settings causing a specific output current at the highest power obtainable from the solar cell SC1. At times when the central controller carries out a maximum power point tracking algorithm with respect to the DC/DC converter DD1 and solar cell SC1, the converter controller C1 drives the switch mode converter SW1 according to the instructions received from the central controller CC via the control input CI1.

The converter controller C1 also gathers data from the inputs and outputs and internal elements of the switch mode converter SW1 and transmits a selected set of these to the central controller CC via the data output DO1, either automatically according to a predefined scheme or on request.

FIG. 7 illustrates an embodiment of a DC/DC converter DD1 according to the present invention in more detail. Beside the elements also comprised in FIG. 6, the embodiment of FIG. 7 comprises a galvanic separation GS on the communication link between the converter controller C1 and the communication bus connected to the other DC/DC converters and the central controller CC. As described above, the galvanic separation GS may be implemented by means of any known galvanic separation means, e.g. transformers, optocouplers or capacitors, etc.

FIG. 7 further comprises a switch mode converter synchronization signal SWS between the converter controller C1 and the switch mode converter SW1. As described above, the control signal from the central controller in a preferred embodiment comprises a synchronization signal, e.g. a clock signal, which the converter controller C1 may use to clock the switching stage SW1, possibly after performing an appropriate clock division. The synchronisation signal may in an alternative embodiment, however, also be provided to the switch mode converter SW1 by separate wiring, e.g. directly from a system clock generator.

FIG. 7 further comprises a controller power supply CPS arranged to supply the converter controller C1 directly from the solar cell or array of solar cells SC1. By this local supply, the need for drawing power supply lines to all the local DC/DC converters from a central power supply, is avoided, but it is even more advantageous that the converter controller C1 is able to operate its communication interface to receive instructions from the central controller or send status and measurement information back, and it is able to control and set working conditions of the switch mode converter SW1 to get it started in good order. Obviously, the controller power supply CPS will only be able to provide power when the solar cells are sufficiently illuminated. This fact, however, also means that the converter controllers automatically wake up with the sun or other illumination source in turn, and are able to communicate this to the central controller. In a preferred embodiment, the controller power supply CPS comprises a small amount of power storage, e.g. a capacitor, with enough power storing capability to supply the converter controller C1 as long as it takes to tell the central controller that the light has gone or something has failed, and shut the DC/DC converter down in an orderly manner or slowly enough for the rest of the system to adapt smoothly to the change.

FIG. 7 further comprises an input filter on the connection from the solar cells, for reducing the amount of electromagnetic interference reaching the converter or being send from the converter along the connections to the cell.

In a preferred embodiment of the invention, the DC/DC converter DD1 further comprises ancillary components such as e.g. filtering elements, voltage, current and temperature senses, etc.

It is noted that the different aspects of the different embodiments of power generation systems and DC/DC converters described above may be combined with each other to create other embodiments also entirely within the scope of the present invention. In particular, the parallel coupling embodiment of FIG. 5 may be combined with any of the additional features of the more advanced series coupling embodiments of FIG. 2-4, and the different additional features of FIG. 7 as compared to FIG. 6, may be used separately or in different combinations, e.g., with the embodiment of FIG. 5, or any of the variations suggested with reference to the embodiments of FIGS. 1 to 5 may be used with the embodiments of FIG. 6 or FIG. 7.

1.-41. (canceled)

42. A power generation system comprising
a system intermediate output,
a system DC/DC converter coupled to said system intermediate output and providing a system output,
a central controller,
at least two solar cells, and
at least two DC/DC converters each comprising
a power input for connecting to an output of one or more of said at least two solar cells,
a power output,
a converter controller comprising a processor for carrying out a local maximum power point tracking algorithm, and
a data output for transmitting DC/DC converter data to said central controller;
wherein said power outputs of said at least two DC/DC converters are coupled in series to establish an accumulated system output voltage at said system intermediate output, and wherein said central controller is arranged to control an input state of said system DC/DC converter on the basis of said DC/DC converter data.

43. The power generation system according to claim 42, wherein said input state of said system DC/DC converter is selected from a list of at least one or more of
a state of seeking a predetermined input power,
a state of seeking a predetermined input current,
a state of seeking a predetermined input voltage, and
a state of seeking a predetermined input voltage and a predetermined input current.

44. The power generation system according to claim 42, wherein said central controller is arranged to control a system output state of said system DC/DC converter, said system output state being selected from a list of at least one or more of
a state of contributing power,
a state of not contributing power,
a state of seeking a predetermined output power,
a state of seeking a predetermined output current,
a state of seeking a predetermined output voltage,
a state of seeking a predetermined output pulse frequency, and
a state of seeking a predetermined output pulse duty cycle,
or combinations thereof.

45. The power generation system according to claim 42, wherein said DC/DC converter data comprises one or more of power input values, power output values, and internal DC/DC converter values.

46. The power generation system according to claim 42, comprising an inverter coupled to said system output and providing a system AC output, wherein said central controller is arranged to control an inverter output state of said inverter, said inverter output state being selected from a list of at least one or more of
a state of contributing power,
a state of not contributing power,
a state of seeking a predetermined output power,
a state of seeking a predetermined output current,
a state of seeking a predetermined output voltage,
a state of seeking a predetermined output frequency, and
a state of seeking a predetermined output phase,
or combinations thereof.

47. The power generation system according to claim 42, comprising at least one measuring module arranged to determine at least one characteristic of said system intermediate output, wherein said central controller is arranged to receive one or more of said at least one characteristic from said at least one measuring module.

48. The power generation system according to claim 42, wherein said converter controllers are powered from corresponding said power inputs.

49. The power generation system according to claim 46, wherein said central controller is arranged to receive information from said inverter, and where said power generation system comprises a data interface for transmitting information to an external recipient and/or for receiving control data from an external source.

50. The power generation system according to claim 42, wherein said at least two DC/DC converters each comprises a control input, and wherein said central controller is arranged to control via said control inputs, an output state of each of at least two of said DC/DC converters.

51. The power generation system according to claim 50, wherein said output state of each of at least two of said DC/DC converters is selected from a list of at least one or more of
a state of contributing power,
a state of not contributing power,
a state of seeking a predetermined output power,
a state of seeking a predetermined output current,
a state of seeking a predetermined output voltage, and
a state of seeking a predetermined output voltage and a predetermined output current.

52. The power generation system according to claim 50, wherein said central controller is arranged to control, via said control inputs, a local maximum power point tracking algorithm of each of at least two of said DC/DC converters.

53. A method of operating a power generation system comprising a plurality of solar cells and a plurality of DC/DC converters each connected to at least one of said plurality of solar cells and carrying out local maximum power point tracking and having their power outputs coupled in series to provide an accumulated system output voltage and a system current at a system intermediate output,
whereby a system DC/DC conversion is carried out on said system intermediate output to establish a system output, said system DC/DC conversion being controlled by a central controller on the basis of DC/DC converter data of at least two of said DC/DC converters in order to control said accumulated system output voltage and/or said system current at said system intermediate output.

54. The method of operating a power generation system according to claim 53, whereby said central controller controls said system DC/DC conversion in order to seek at least one of a predetermined input power, a predetermined input current, and a predetermined input voltage.

55. The method of operating a power generation system according to claim 53, whereby said central controller controls said system DC/DC conversion in order to seek one or more of
a state of contributing power,
a state of not contributing power,
a predetermined output power,
a predetermined output current,
a predetermined output voltage,
a predetermined output pulse frequency, and
a predetermined output pulse duty cycle.

56. The method of operating a power generation system according to claim 53, whereby said DC/DC converter data comprises one or more of input, output and internal values of at least two of said DC/DC converters via data outputs.

57. The method of operating a power generation system according to claim 53, whereby a DC/AC conversion is carried out on said system output to establish a system AC output, and whereby said central controller controls said DC/AC conversion in order to seek one or more of
a state of contributing power,
a state of not contributing power,
a predetermined output power,
a predetermined output current,
a predetermined output voltage,
a predetermined output frequency, and
a predetermined output phase.

58. The method of operating a power generation system according to claim 53, whereby said plurality of DC/DC converters comprises converter controllers that are powered from corresponding said connected solar cells.

59. The method of operating a power generation system according to claim 57, whereby said central controller receives information about input, output and/or intermediate values in relation to said AC/DC conversion, and whereby a data interface is provided for transmitting information to an external recipient and/or for receiving control data from an external source.

60. The method of operating a power generation system according to claim 53, whereby a central controller controls an output state of each of at least two of said DC/DC converters.

61. The method of operating a power generation system according to claim 60, whereby said output state of each of at least two of said DC/DC converters is selected from a list of at least one or more of
a state of contributing power and
a state of not contributing power,
a state of seeking a predetermined output power,
a state of seeking a predetermined output current,
a state of seeking a predetermined output voltage, and
a state of seeking a predetermined output voltage and a predetermined output current.

62. The method of operating a power generation system according to claim 60, whereby said central controller controls said output state of each of at least two of said DC/DC converters at least partly on the basis of least one characteristic of a system intermediate output.

63. The method of operating a power generation system according to claim 53, whereby said central controller controls said local maximum power point tracking.
